(19) United States
(12) Patent Application Publication
(10) Pub. No.: US 2002/0070975 A1
(43) Pub. Date: Jun. 13, 2002

(54) System and method for enhancing software GUI

(76) Inventors: Thomas E. Sawicki, Huntersville, NC (US); James R. Wooden, Charlotte, NC (US)

Correspondence Address: RICHARD L. CATANIA, ESQ., SCULLY, SCOTT, MURPHY AND PRESSER, 400 Garden City Plaza, Garden City, NY, 11530, US

(21) Appl. No.: 09/732,406

(22) Filed: Dec. 7, 2000

(51) Int. Cl. G09G 5/00

(52) U.S. Cl. 345/801

(57) ABSTRACT

A system and method for enhancing graphical user interface (GUI) displays by providing a single axis magnifying lens effect, that provides for the altering of selected data by modifying a character's aspect ratio. Thus, in one aspect, a displayed character at a given font size may be altered by making the character taller without changing the character's width. Alternately, a displayed character at a given font size may be altered by making the character wider, but not taller. Thus, the data density of the information presented is not disturbed in the axis orthogonal to the single axis being magnified.

### BACKGROUND OF THE INVENTION

1. Field of the Invention

This invention relates generally to graphical user interfaces, and more specifically, to a system and method for enhancing viewing image of software GUIs to aid in data entry and review.

2. Discussion of the Prior Art

In working with data presented via a video display terminal (VDT) the most common presentation formats are either row-wise or row-and-column data. Typically, user interaction with such data involves two separate and distinct modes:

1) Data entry/review for accuracy/transcription. In this mode accurate interpretation by the user of the data presented on the VDT is crucial. If a “6” is confused for an “8”, for example, the results could be disastrous. Users operating in this mode tend to select a larger point size for the font(s) being used in order to minimize eye strain and to insure accuracy.

2) Data record locating/scanning or cursory review, in which the user is simply trying to locate a particular data record (a data record in this case being defined as a row or column of data) or element. To allow maximum efficiency in this mode of interaction, a smaller font is generally selected. This allows for maximum visual “data density”, and thereby minimizes the amount of panning or scrolling the screen represented data to locate the desired record/element.

Generally, users must toggle between these two modes of interaction in order to perform the task at hand. First, scanning (for example) a spreadsheet to locate the column or row of data that requires updating or from which information must be extracted, and then taking the next logical step of actually updating or extracting the data.

These modes of operation present conflicting requirements. While the selection of a small (i.e., smaller point size) font is effective for casual scanning and locating of a desired data record it presents accuracy issues if the data record, once located, needs to be updated, or manually transcribed to some other document. The high data density is no longer appealing as is now impedes the accuracy with which the data can be edited or transcribed. Likewise, the larger font sizes that enhance accuracy when entering or transcribing data impede the “search” process as the larger font implies a reduced data density and, thus, requires additional scrolling or panning of the displayed data set in order to locate the desired record.

The patent literature is replete with descriptions that are directed to 2-axis or “area” related image manipulation, panning, zooming, etc. Representative of these are U.S. Pat. No. 4,800,379 which is directed to an image display with movable magnification; U.S. Pat. No. 4,720,703 which is directed to a display method and apparatus employing cursor panning; U.S. Pat. No. 5,187,776 which is directed to image editor zoom function; and, U.S. Pat. No. 4,751,507 which is directed to a method for simultaneously displaying an image and an enlarged view of a selectable portion of the image with different levels of dot detail resolution.

There is a distinct need in the art to enable a viewer to alter the image of selected displayed data/characters in accordance with user needs by magnifying a particular axis of the displayed character without reducing the visual data density in the orthogonal axis to the axis being magnified, i.e., a single axis magnifying lens effect.

It would therefore be highly desirable to provide a method and mechanism for enabling a user to alter a displayed character font representing the data in a particular row or column of a displayed data record to facilitate a desired viewing requirement such as scanning/locating or data entry/viewing.

It would additionally be highly desirable to provide an improved software graphical user interface (GUI) enhancement technique designed to alter one or more displayed characters by modifying their aspect ratio in accordance with user viewing requirements.

### SUMMARY OF THE INVENTION

It is an object of the present invention to provide a method and mechanism for enabling a user to alter a displayed character font representing the data in a particular row or column of a displayed data record to facilitate a desired viewing requirement such as scanning/locating or data entry/viewing.

It is a further object of the present invention to provide a method and mechanism for providing an improved software graphical user interface (GUI) enhancement technique designed to alter one or more displayed characters by modifying their aspect ratio in accordance with user viewing requirements.

The present invention overcomes the conflicting requirements presented by GUI data displays by enabling toggling of selected display data at a small (i.e., smaller point size) font to facilitate casual scanning and locating of a desired data record due to resulting increased data density and, once located, presenting the located data that needs to be updated, edited, or manually transcribed to some other document at a large (i.e., larger point size) font. This invention preferably is embodied as a software enhancement to the operating system or software application package.

In accordance with preferred embodiment of the invention, there is provided a system and method for enhancing graphical user interface (GUI) displays by providing a single axis magnifying lens effect, that provides for the altering of selected data by modifying a character's aspect ratio. Thus, in one aspect, a displayed character at a given font size may be altered by making the character taller without changing the character's width. Alternately, a displayed character at a given font size may be altered by making the character wider, but not taller. Thus, the data density of the information presented is not disturbed in the axis orthogonal to the single axis being magnified.

Advantageously, the single-axis single axis magnifying lens technique according to the invention is beneficial to all types of users, especially the visually impaired, and besides spreadsheet programs, maybe activated for use in many other applications including word or text processors.

### BRIEF DESCRIPTION OF THE DRAWINGS

Further features, aspects and advantages of the apparatus and methods of the present invention will become better understood with regard to the following description, appended claims, and accompanying drawings where:

FIG. 1(a) illustrates implementation of the present invention according to a first embodiment of the invention.

FIG. 1(b) illustrates implementation of the present invention according to a second embodiment of the invention.

FIG. 2 illustrates another implementation of the vertical expansion feature applied to selected words 30 of a word processing text 35.

### DETAILED DESCRIPTION OF THE PREFERRED EMBODIMENTS

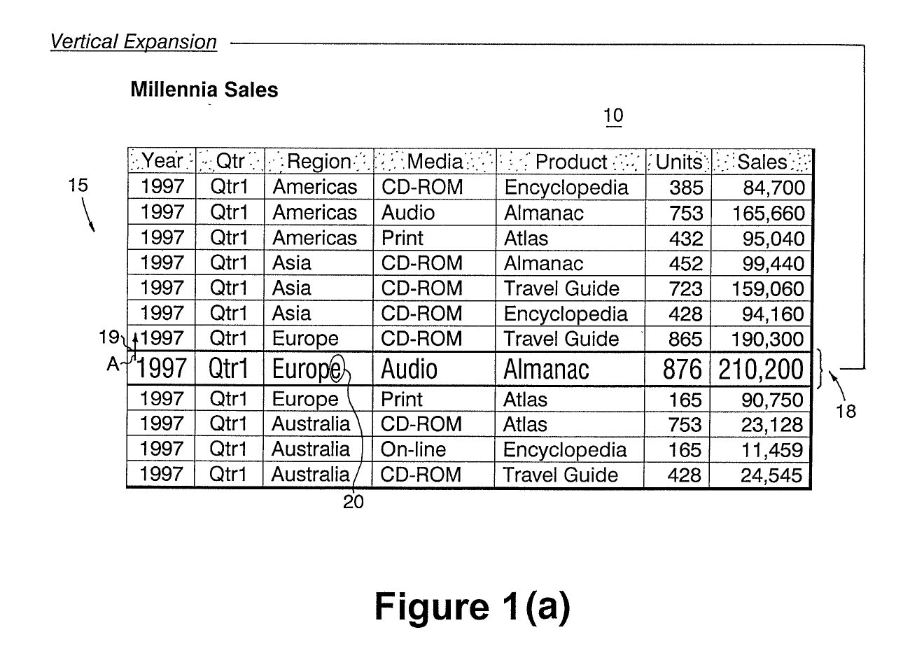

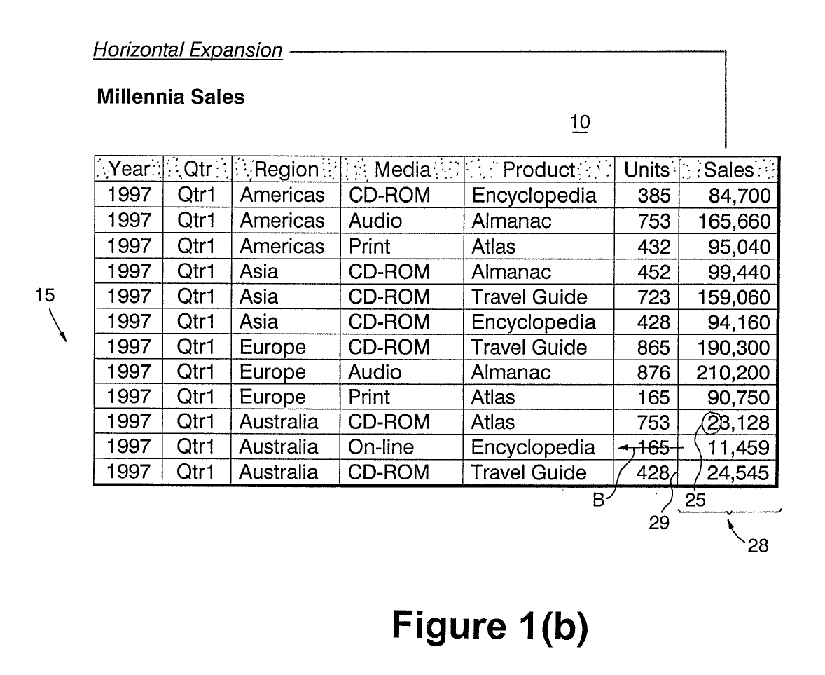

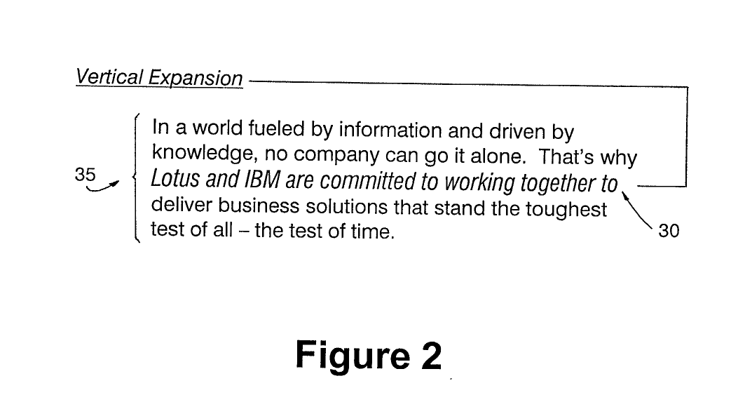

According to the principles of the invention, FIG. 1(a) illustrates a VDT display 10 comprising a plurality of data records 15. If the data records being manipulated are stored in a row-wise method, the invention in accordance with a first embodiment is to enable a characters' height to be altered while keeping their width constant for characters in a selected row. Thus, as shown in FIG. 1(a), the user enables a vertical expansion feature for a selected row to be manipulated, e.g., row 18, whereby the characters 20 are magnified vertically, while each the character's width remains the same. FIG. 2 illustrates another implementation of the vertical expansion feature applied to selected words 30 of a word processing text 35.

FIG. 1(b) illustrates a VDT display 10 comprising the same data records 15 as in FIG. 1(a). If the data records being manipulated are stored in a column-wise method, the invention in accordance with a second embodiment is to enable a characters' width to be altered while keeping their height constant for characters in a selected column. Thus, as shown in FIG. 1(b), the user enables a horizontal expansion feature for a selected row to be manipulated, e.g., column 28, whereby the characters 25 are magnified horizontally, while the character's height remains the same.

As can be seen from FIGS. 1(a) and 1(b), the data density of the information presented in the display 10 is not disturbed in the orthogonal axis, i.e., the axis of the character not being magnified (altered vertically or horizontally). Thus, the original data density in the orthogonal axis is retained allowing the user to invoke a high data density display for scanning/searching operations, while at the same time (by positioning the single-axis magnifying “lens” on the desired data record) allowing maximum accuracy in interpreting the newly located data and/or comparing it to data in adjacent records/cells.

In the preferred embodiment, the user controls when the feature is enabled/disabled. For example, once the single-axis magnifier mode is enabled, a user may manipulate a mouse pointer to grab a row-wise or column-wise dividing line of the data record to be modified, and move the line location so as to modify the data characters adjacent the line to a desired degree of magnification in accordance with the respective single-axis magnification feature enabled. For instance, as shown in FIG. 1(a), a user may implement a mouse pointer to grab the dividing line 19 for row 18, and, in the direction of arrow “A” move the location of the line so as to adjust the degree of vertical magnification for characters 20 in the row. Likewise, as shown in FIG. 1(b), a user may implement a mouse pointer to grab the dividing line 29 for column 28, and, in the direction of arrow “B” move the location of the line so as to adjust the degree of horizontal magnification for characters 25 in the column. As mentioned, the degree of single-axis magnification is controllable by the user. For example, a degree of expansion of 200-300% is not uncommon, which represents font size magnification from 6-8 point size to 12-15 point size in the desired dimension.

While the invention has been particularly shown and described with respect to illustrative and preformed embodiments thereof, it will be understood by those skilled in the art that the foregoing and other changes in form and details may be made therein without departing from the spirit and scope of the invention which should be limited only by the scope of the appended claims.

Having thus described our invention, what we claim as new, and desire to secure by Letters Patent is:

1. A magnifying lens technique for a graphic display comprising:
mechanism enabling user to select graphically displayed characters from a computer display terminal;
mechanism for visually altering an aspect ratio of each of said graphically displayed characters by magnifying said character along a single axis, whereby an original data density for the character in an axis orthogonal to said single axis is retained.

2. The magnifying lens technique according to claim 1, wherein said single axis includes a vertical axis, the original data density of said character in the horizontal dimension remaining the same.

3. The magnifying lens technique according to claim 1, wherein said single axis includes a horizontal axis, the original data density of said character in the vertical dimension remaining the same.

4. The magnifying lens technique according to claim 1, wherein said display includes a grid of rows and columns comprising characters or text, said mechanism for enabling a user to select graphically displayed characters further enabling the selection of characters or text from a row to be altered.

5. The magnifying lens technique according to claim 1, wherein said display includes a grid of rows and columns comprising characters or text, said mechanism for enabling a user to select graphically displayed characters further enabling the selection of characters or text from a column to be altered.

6. The magnifying lens technique according to claim 1, further including mechanism for enabling a user to control a degree of said single-axis magnification.

7. A method for altering characters in a graphic display comprising the steps of:
enabling user to select graphically displayed characters from a computer display terminal;
visually altering an aspect ratio of each of said graphically displayed characters by magnifying said character along a single axis, whereby an original data density for the character in an axis orthogonal to said single axis is retained.

8. The method according to claim 7, wherein said single axis includes a vertical axis, the original data density of said character in the horizontal dimension remaining the same.

9. The method according to claim 7, wherein said single axis includes a horizontal axis, the original data density of said character in the vertical dimension remaining the same.

10. The method according to claim 7, wherein said display includes a grid of rows and columns comprising characters or text, said method further including enabling the selection of characters or text from a row to be altered.

11. The method according to claim 7, wherein said display includes a grid of rows and columns comprising characters or text, said mechanism for enabling a user to select graphically displayed characters further enabling the selection of characters or text from a column to be altered.

12. The method according to claim 7, further including the step of enabling a user to control a degree of said single-axis magnification.
